(19) United States
(12) Patent Application Publication
(10) Pub. No.: US 2007/0128090 A1
(43) Pub. Date: Jun. 7, 2007

(54) Wet electrostatic liquid film oxidizing reactor apparatus and method for removal of NOx, SOx, mercury, acid droplets, heavy metals and ash particles from a moving gas

(75) Inventors: Isaac Ray, Brooklyn, NY (US); Mark A. West, Kildeer, IL (US); Boris Altshuler, North Miami Beach, FL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Eisenmann Corporation, Crystal Lake, IL (US)

(21) Appl. No.: 11/635,465

(22) Filed: Dec. 6, 2006

Related U.S. Application Data
(60) Provisional application No. 60/742,716, filed on Dec. 6, 2005.

(51) Int. Cl. B01D 53/56; B01J 19/08; B01J 19/12

(52) U.S. Cl. 422/186.03; 423/235; 422/186.04

(57) ABSTRACT

A method and apparatus for the oxidation of NO, SO₂, and mercury vapors and their subsequent removal from a waste gas together with solid submicron particles and acid droplets comprising the reagent injection, WESP/plasma reactor, liquid film catalytic reactor and FGD scrubber with WESP/mist eliminator for the final gas cleaning.

### CROSS-REFERENCE TO RELATED PATENT APPLICATIONS

This patent application claims the benefit of U.S. Provisional Patent Application No. 60/742,716, filed Dec. 6, 2005.

### FIELD OF THE INVENTION

This invention pertains to a pollution control method and apparatus used to reduce particulate matter and emissions resulting from the burning of fossil fuels and more particularly, for the removal of submicron solid and liquid particles and oxidation of NOₓ, SO₂, and Hg vapors to allow for their subsequent removal in a scrubber that is equipped with wet electrostatic precipitator (WESP) acting as a mist eliminator.

### BACKGROUND OF THE INVENTION

Federal laws and environmental regulations have made it necessary for operators of manufacturing plants and electrical power facilities to install equipment that removes the harmful particulate matter and emissions that result from the combustion of fossil fuels. A method of removing such pollution is disclosed in U.S. Pat. No. 6,132,692 (Alix et al.), the contents of which are incorporated herein by reference. The method disclosed in Alix et al provides highly efficient, economical and compact means for removing both particulate matter (PM-10 and PM-2.5) and toxic gases simultaneously.

In Alix et al, the contaminated gas stream is cleaned by oxidizing the gases and mercury in a barrier discharge reactor. This process requires a substantial amount of electrical energy. The cost of the electrical energy along with the high capital cost of the barrier discharge reactor as well as the costs associated with the manufacture and operation of the ozone generator; which contains glass or ceramic tubes and requires a cooling system make the known emission control process very expensive.

All industrial ozone generators require filters for the air pre-cleaning. These generators are also more economical to use with the injection of oxygen instead of clean ambient air. Under no circumstances, however, can the barrier discharge ozone type reactor be used with dirty flue gas without incurring frequent shutdowns and high maintenance costs.

Although it is possible to place a barrier discharge reactor outside of the gas stream and inject radicals into the gas, because the lifetime of the radicals is very short the oxidation process will not be effective. Therefore, an improved method and apparatus that provides highly efficient, economical and compact means for removing both particulate matter (PM-10 and PM-2.5) and toxic gases simultaneously would be an important improvement in the art.

The present invention overcomes the disadvantages of the prior art by providing for oxidation directly in the moving contaminated gas where the short living radicals have a chance to provide the oxidation. The invention also provides a robust and economical design of a reactor that can be placed in the moving hot and contaminated exhaust gas generated by a coal-fired utility boiler, incinerator or other industrial application and still operate with minimum maintenance and off-line time.

The invention also overcomes the shortcomings of the prior art by providing, in addition to the high voltage plasma oxidation, chemical oxidation by employing the combined oxidizing and catalytic property of collected submicron ash containing heavy metals, oxidizing chemicals and by employing the electrical power in the most economical combination. This is because the amount of electrical energy required for oxidation with electrical power only of the flue gas components from the utility boiler and to comply with current regulations will amount to about 6% of total generated power.

The invention also provides for the continuous self-cleaning of the collection and oxidizing surfaces. This is of paramount importance in utility or industrial processes that cannot be shutdown to allow for the washing of the catalytic oxidizer or internals of the gas cleaning apparatus.

Finally, the invention also provides for the continuous movement of a liquid film of constant viscosity on the surface of the liquid film catalytic reactor by proportional injection of the make-up water related to the changes in the concentration of the incoming ash from the upstream particulate removal system.

### BRIEF SUMMARY OF THE INVENTION

The method and the apparatus of present invention relates to the art of removal of submicron particulate of ash and heavy metals, including mercury vapors and condensed mercury, from the stream of industrial waste gas while simultaneously scrubbing the moving gas of toxic gases such as SO₂, NOₓ, SO₃.

The inventive apparatus includes a reagent (halogen oxosalts intermixed with corrosion inhibitor, for instance Sodium Nitrate) injection system, a wet electrostatic precipitator (WESP) with negatively charged ionizing electrodes and positively charged (grounded) collecting elements, on the surface of which collected reagent liquid droplets of oxidizing chemicals such as sodium chlorite or sodium chlorate are intermixed with sulfuric acid mist, particles of fine ash from the last field of the dry electrostatic precipitator (ESP) containing most of the heavy metals, and mercury from the burned fuel flowing vertically downward into the liquid film oxidizing reactor. In one embodiment the reagent may contain 0.1% of a corrosion inhibitor such as sodium nitrate.

Gas to be cleaned enters the apparatus at a temperature ranging from 350° to 400° F. This causes partial evaporation of the water from the reagent chemicals solution thus concentrating the solution and providing beneficial conditions for interaction between molecules of nitrogen oxides, SO₂, mercury, and vapors of the newly formed reagent product in the gas phase. These reactions in the gas phase are much more effective than reactions between the solid or liquid droplets reagent and the gaseous pollutants.

When in operation, the droplets of the concentrated reagent'solution are being collected on the surface of the plates or tubes of the WESP as described above. A pulsing high voltage electrical field is maintained between the positively charged collecting elements and the negatively charged high voltage electrodes not only for collection of ash particles and reagent droplets, but also for production of a non-thermal plasma with energetic electrons in order to create radicals, such as atomic oxygen O, Ozone, O₃, and hydroxyl, OH, that occurs due to the collision of electrons with molecules of water and oxygen that are present in the flue gas or injected reagent solution.

In addition to the gas phase oxidation reaction between the flue gas and evaporated liquid of the reagent, the gas-phase radicals oxidize NOₓ, SO₂, and mercury converting them in to NO₂, sulfuric acid, nitric acid and mercuric chloride or mercuric oxide for further removal in the flue gas desulfurization (FGD) scrubber with a WESP acting as a mist eliminator.

In order to fully utilize the chemical activity of the reagent and minimize the cost of the chemicals and electrical energy for plasma generation, the reaction between the gas and slurry of the mixture of the reagent and collected ash particles continues to take place in the liquid film reactor which, in effect, is an additional array of the grounded collecting elements of the electrostatic portion of the apparatus.

Since the grounded collecting elements of the reactor do not have negative ionizing electrodes between them, there is no limitation to the spacing between the plates or tubes due to the sparking that is limiting the operating voltage. Therefore, the reactor surface can be much denser, thereby leading to much higher mass transfer capability of the oxidation process.

The collecting elements created by the plates or tubes of the liquid film reactor provide additional collection efficiency for charged droplets and particles that have escaped the electrostatic portion of the apparatus but still possess the electrostatic charges and thus become subjected to the mirror image force attraction between the charged droplets, charged particles, and the grounded surface of the liquid film reactor.

### BRIEF DESCRIPTION OF THE DRAWINGS

FIG. 1 is a vertical cross-sectional view of the inventive apparatus constructed in accordance with the features of the present invention.

### DETAILED DESCRIPTION OF THE INVENTION

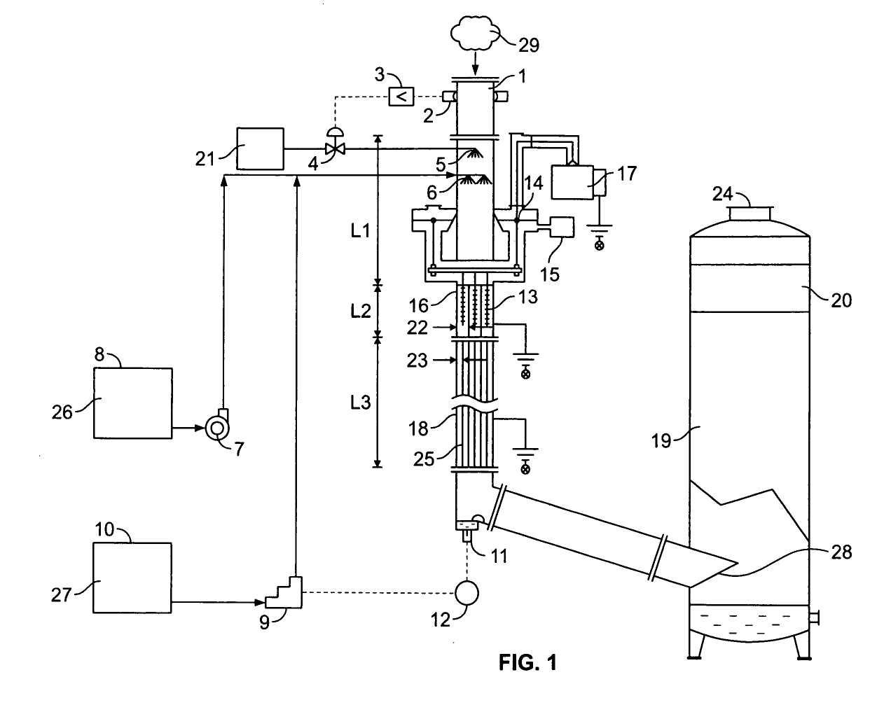

The following examples further illustrate the invention but, of course, should not be construed as in any way limiting its scope. Referring now to the FIG. 1, hot and contaminated industrial waste gas 29 from a dry ESP enters the apparatus through an inlet transition 1 that includes an optical sensor 2 that measures the inlet ash concentration of the gas. This optical sensor 2 is connected to a controller 3 that is used to operate a valve 4 in order to adjust the amount of the make-up water 21 volume that flows to a nozzle 5 connected to the apparatus.

Along with the flow of water, a reagent 26 having a corrosion inhibitor is transferred from a storage tank 8 via a pump 7 through a second nozzle 6 so as to provide a continuous spray.

According to the chemical process described below, the oxidation process requires an acidic environment (i.e., pH=4-6.5) for the most beneficial results. Therefore, based on the signal from the pH sensor 11 and pH controller 12, additional acid 27 is delivered by the metering pump 9 from an acid tank 10. One additional positive effect of the acidic environment is the minimization of the formation of residue, such as calcium sulfate and calcium carbonate that is very difficult to remove from the surface of the plates or tubes.

During operation, water droplets and moisture from the reagent droplets provided by the nozzles 5 and 6 evaporate as they move downwards in the region L1 through the apparatus along with the hot gas that cools down to saturation temperature.

While most of the gas phase reactions take place in region L1 of the apparatus, portions of the moisture of the reagent that did not evaporated create a very concentrated reagent slurry that, along with particles of ash and the droplets of condensed acid, are precipitated in the WESP region L2 that includes a network of negatively charged ionizing electrodes 13 suspended from insulators 14 and an air purge system 15 to keep the insulators dry and clean.

Each of the ionizing electrodes 13 is located in the centre of an array of tubes or plates 16 that are grounded and connected to a positive terminal of a high voltage pulsing power source 17. In this invention, the term “plates” means tubes or plates. Since the geometry of the collector (16 and 25) is not germane to the spirit of the invention and therefore any suitable geometric shape may be utilized without departing from the spirit and scope of the invention.

Precipitated particles of ash along with collected droplets of the concentrated reagent and acid create the liquid film of slurry that is continuously moving downward with the gas along the surface of the catalytic reactor 18. The reactor 18 is comprised of plates 25 or tubes located closer to each other that the grounded elements 16.

In the absence of the negative electrodes in the vicinity of the reactor 18 plates 25 or tubes, the distance 23 between the plates 25 or size of the tubes is selected for the proper ratio between surface area and reactor volume for a required level of oxidation and optimum mass transfer conditions. Since the grounded plates 25 (collecting elements) of the reactor 18 do not have negative ionizing electrodes between them, there is no limitation to the spacing between the plates 25 or tubes due to the sparking that is limiting the operating voltage. Therefore, the reactor surface can be much denser, thereby leading to much higher mass transfer capability of the oxidation process. Thus the distance 23 between the reactor plates 25 may be smaller than the distance 22 between the plates 16 of the WESP region L2.

This very developed active surface area with moving slurry acts as a continuous self-rejuvenating and self-cleaning catalyst.

Additional oxidation takes place during the prolonged contact time between the gas and the film of moving slurry in the region L3 of the reactor 18.

Since the reactor 18 can be a part of the long ductwork to the inlet 28 at the bottom of the FGD scrubber 19, the residence time of more than 2 seconds will take place in the reactor within the available space that is very important for the oxidation process and for the modification of the existing plants with limited room for expansion.

Slurry and gas with newly formed particles of oxides are entering the FGD scrubber 19 with a WESP 20, acting as a mist eliminator, for final removal of all solid and liquid particles coming from the boiler or particles newly created during the oxidation and scrubbing process. Clean gas leaves the outlet 24 connected to the WESP 20.

The chemical reactions and chemical process details of the invention can be described as follows.

The contaminated hot flue gas after dry ESP or baghouse contains nitrogen oxides (NO and NO₂), sulfur dioxide (SO₂), sulfur trioxide (SO₃), heavy metals and elemental mercury (Hg) that must be removed before discharge to the atmosphere.

The SO₂ and nitrogen dioxide (NO₂) will be removed by wet flue gas desulfurization system (FGD) scrubber 19. Nitrogen oxide (NO) and elemental mercury are insoluble in water and the removal efficiency of the wet scrubbing systems for those chemicals is practically negligible. Therefore, in order to facilitate their removal, they must be oxidized.

It is known that the oxidation of insoluble nitrogen oxide (NO) into the soluble form of nitrogen dioxide (NO₂) can be accomplished by ozone (O₃) oxidation, which can be produced by an ozone generator and injected in the contaminated gas stream. In the case of the proposed invention, however, ozone is generated in the WESP region L2 of the apparatus.

Furthermore, the oxidation of nitrogen oxide to the nitrogen dioxide can be performed directly in the gas phase by the use of chlorine dioxide (ClO₂) which is less expansive than ozone.
2NO+ClO₂+H₂O═NO₂+HCl+HNO₃ (1)

The residence time in the apparatus required for this gas phase reaction is less than 2 seconds in order to have 95% efficiency of NO oxidation.

Elemental mercury after oxidation by ClO₂ forms the mercury oxide that is a fine particle:
5Hg+2ClO₂+H₂O═5HgO+2HCl. (2)

According to the invention chlorine gas (Cl₂) will be formed in the apparatus as well and will react with mercury forming the soluble mercury chloride:
Hg+Cl₂═HgCl₂ (3)

The soluble NO₂ and HgCl₂ will be removed by the FGD 19 scrubbing system. However, fine particles of the mercury oxide can only be removed by the WESP 20 that also acts as a mist eliminator for the FGD scrubber 19.

Chlorine dioxide cannot be compressed or stored commercially as a gas because it explodes under pressure. It can, however, be generated using various halogen oxoacids or sodium or potassium oxosalts such as NaOCl (sodium hypochlorite), NaClO₂ (sodium chlorite), NaClO₃ (sodium chlorate) or NaClO₄ (sodium perchlorate).

According to the invention sodium chlorite (NaClO₂) or sodium chlorate (NaClO₃) are used to generate chlorine dioxide directly in the apparatus. One of the methods of chlorine dioxide generation is the reaction of sodium chlorite with different acids, for example:
5NaClO₂+2H₂SO₄═2Na2SO₄+2H₂O+NaCl+4ClO₂ (4)
2NaClO₃+H₂SO₄+SO₂═2NaHSO₄+2ClO₂ (5)
2NaClO₃+4HCl═2NaCl+2H₂O+Cl₂+2ClO₂ (6)

In addition to the chlorine dioxide (reactions 4, 5), the gas contains no less than 20% of free chlorine that reacts with mercury (see reaction (3)). Moreover, the chlorine dioxide at a temperature above 54° F. (12° C.) contains various reactive radicals which will provide the additional oxidation of nitrogen oxide and mercury.

According to the invention the choice of the acid 27 that is supplied from the tank 10 (FIG. 1) depends upon the main pollutant that have to be removed from the gas, for example, if the flue gas should be clean from mercury, the generation of chlorine is preferable for the reaction (3) to form the soluble mercury chloride HgCl₂. In this example, the chlorine generation, according to the invention could be accomplished using the following reactions of sodium chlorate (NaClO₃), or sodium hypochlorite (NaOCl) with the HCl and CO₂ acids:
2NaClO₃+4HCl═2ClO₂+Cl₂+2NaCl+2H₂O (7)
2NaOCl+2HCl═Cl₂+2NaCl+H₂O (8)
4NaOCl+2CO₂═2Na2CO₃+2O₂+2Cl₂ (9)

The stability of all halogen oxoacids and halogen oxosalts is reduced under increasing temperature and concentration of anionic impurities such as Cl, CO₃, SO₄ and cationic impurities which include Ni, Ca, Mg, Cu, and Fe.

The ash from the coal-fired boiler that will be collected on the walls of plates 16. (or tubes) of the WESP region L2 together with oxosalts contains more than 2% of calcium oxide and 1% of magnesium oxide. Therefore, the collected ash will act as a catalyst for all desirable decomposition reactions of the halogen oxosalts used in the process.

Moreover, since material of construction for the collector plates 16 in the WESP region L2 is corrosion resistance alloy, which always contains high concentration of Ni, then traces of nickel will be present in the liquid film of reactive solution and will also provide catalytic effect for decomposition of halogen oxosalts.

An additional source of the chlorine dioxide is a decomposition of halogen oxosalts on the surface of the WESP collector plates 16 due to the electrochemical reaction:
ClO₂′═ClO₂+e′ (10)

The additional positive effect from the aqueous liquid film in the high voltage area is the result of the formation of various reactive compounds such as OH, O radicals and ozone. Those radicals or ozone will react with nitrogen oxide and mercury, thereby converting them in to the nitrogen dioxide and mercury oxide that will be removed in the FGD scrubber 19 equipped with the WESP 20 as a mist eliminator.
NO+O₃═NO₂+O₂ (11)
Hg+O₃═HgO+O₂ (12)

According to the invention the inlet 1 section and electrostatic section L2 of the apparatus are fabricated from heavy gage alloy steel and by the use of corrosion inhibitor like sodium nitrate (NaNO₃). In the L1 region where there is injected liquid, the alloy used in the various sections can be less expensive molybdenum alloys like AL6XN or 254 SMO rather than Hastelloy C-276.

The liquid film reactor surface can be fabricated from inexpensive plastic material like FRP, CPVC or PVC that on the average cost about $2 per pound compared to the Alloy like Hastelloy C-276 that cost $20 per pound or AL6XN that cost $10 per pound. In one embodiment, the grounded surface of the liquid film reactor may be fabricated from conductive plastic material containing graphite and Nickel powder.

Since the apparatus is located upstream and next to the FGD scrubber 19 that can be as much as 100 feet tall, the length of the plastic section of the liquid film reactor can also be as long as required to provide ample residence time for the oxidation reaction without incurring substantial capital costs and use of additional real estate.

The cost of the known system in the art that uses a barrier discharge reactor is estimated at $150/KW of generated power by the utility boiler. The estimated installed cost of the inventive apparatus is only $80/KW.

In a report prepared for the New York City Department of Environmental Protection (NYCDEP) (see EPA CSO Technology Fact Sheet 832-F-99-021) the cost projection comparison between capital cost for the sewer overflow disinfection system using chlorine dioxide versus system using only ozone has clearly indicated that the system using chlorine dioxide is 20 times less expensive that system using ozone.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An apparatus for removing chemical pollutants and ash particles from an industrial waste gas, the apparatus comprised of:
a sensor adjacent to an inlet section, the sensor capable of measuring a concentration level of ash particles in the industrial waste gas, the sensor connected to a controller that operates a valve connected to a water source;
a first region of the apparatus in flow communication with the inlet;
the water source connected to the first region;
a first storage vessel connected to the first region of the apparatus, wherein the first storage vessel contains a reagent;
a second storage vessel containing an acid, the second storage vessel connected to the first region of the apparatus;
a second region of the apparatus in flow communication with the first region;
a plurality of negatively charged ionizing electrodes located within the second region of the apparatus, the plurality of negatively charged ionizing electrodes being suspended from at least one insulator and in flow communication with an air purge system;
a first plurality of electrically grounded plates surrounding the plurality of negatively charged ionizing electrodes, each of the first plurality of electrically grounded plates separated from one another by a first distance and electrically connected with a positive terminal of a high voltage pulsing power source;
a liquid film catalytic reactor in flow communication with the second region of the apparatus;
a second plurality of electrically grounded plates located in the liquid film catalytic reactor, each of the second plurality of electrically grounded plates separated from one another by a second distance that is less than the first distance;
a pH sensor located in the apparatus; and
a FGD scrubber in flow communication with the liquid film catalytic reactor, the FGD scrubber including a WESP.

2. The apparatus of claim 1, wherein each of the plates in the first plurality of electrically grounded plates contains a cationic impurity that possesses catalytic properties.

3. The apparatus of claim 2, wherein the cationic impurity is Ni.

4. The apparatus of claim 1, wherein a grounded surface of the liquid film catalytic reactor is fabricated from conductive plastic material containing graphite and Nickel powder.

5. The apparatus of claim 1, wherein the sensor is an optical sensor.

6. The apparatus of claim 1, wherein the chemical pollutants removed from the industrial waste gas comprise nitrogen oxides, sulfur oxides, sulfuric acid mist, and mercury.

7. The apparatus of claim 1, further comprising a first nozzle disposed in the first region of the apparatus, wherein the first nozzle is connected to the water source.

8. The apparatus of claim 1, further comprising a second nozzle disposed in the first region of the apparatus, wherein the second nozzle is connected to the first storage vessel.

9. The apparatus of claim 8, further comprising a first pump between the first storage vessel and the second nozzle, wherein the first pump transfers the reagent from the first storage vessel to the second nozzle such that the second nozzle continuously sprays the reagent.

10. The apparatus of claim 1, further comprising a third nozzle disposed in the first region of the apparatus and connected to the second storage vessel.

11. The apparatus of claim 10, further comprising:
a pH controller connected to the pH sensor; and
a second pump connected to the second storage vessel and responsive to a signal from the pH controller.

12. The apparatus of claim 1, wherein the inlet is fabricated from a steel alloy.

13. A method for removing chemical pollutants and ash particles from an industrial waste gas, the method comprising:
injecting water, and injecting droplets of a reagent that includes a corrosion inhibitor into the industrial waste gas;
evaporating at least some moisture from the reagent droplets, thereby creating a concentrated reagent slurry;
precipitating a combination comprised of the concentrated reagent slurry, the ash particles of the industrial waste gas, and droplets of acid, by flowing the combination through a plurality of negatively charged ionizing electrodes surrounded by a plurality of positively charged plates;
creating a liquid film of a second slurry comprised of precipitated particles of ash, precipitated droplets of concentrated reagent slurry, precipitated droplets of acid, and NO;
oxidizing the NO of the liquid film of the second slurry into NO₂;
measuring a pH of the liquid film of the second slurry;
injecting droplets of acid into the industrial waste gas if the pH of the liquid film of the second slurry is below a predetermined level;
flowing the liquid film of the second slurry into a FGD scrubber and a WESP; and
removing all solid and liquid particles from the second slurry.

14. The method of claim 13, further comprising the step of flowing the liquid film of the second slurry over a surface of a catalytic reactor.

15. The method of claim 14, wherein an amount of the injected water is regulated in relation to an amount of ash particles in the industrial waste gas in order to insure that the liquid film of the second slurry is constantly moving in the catalytic reactor.

16. The method of claim 14, further comprising the step of collecting ash particles from the industrial waste gas and using the collected ash particles as catalyst for the decomposition of Oxocompounds.

17. The method of claim 14, further comprising the steps of collecting sulfuric acid mist generated from sulfur in a fuel in a boiler, and decomposing Oxocompounds with the sulfuric acid mist.

18. The method of claim 13, wherein a specific type of acid, dependent upon a targeted chemical pollutant in the industrial waste gas, is added to the reagent to maintain the pH of the liquid film of the second slurry in the range of 4-6.5.

19. The method of claim 13, wherein the injected reagent comprises 0.1% sodium nitrate.

20. The method of claim 13, further comprising the step of oxidizing NO of the industrial waste gas into NO₂.

21. The method of claim 20, further comprising the step of generating chlorine dioxide, wherein the generated chlorine dioxide is used in the step of oxidizing NO of the industrial waste gas into NO₂.

22. The method of claim 13, further comprising the step of generating ozone used in the step of oxiding NO of the liquid film of the second slurry into NO₂.

23. The method of claim 13, further comprising the step of generating chlorine dioxide used in the step of oxiding NO of the liquid film of the second slurry into NO₂.

24. The method of claim 13, wherein the chemical pollutants removed from the industrial waste gas comprise nitrogen oxides, sulfur oxides, sulfuric acid mist, and mercury.

25. A method for removing nitrogen oxides, sulfur oxides, sulfuric acid mist, mercury and ash particles from an industrial waste gas, the method comprising:
injecting water, and injecting droplets of a reagent that includes a corrosion inhibitor into the industrial waste gas;
evaporating at least some moisture from the reagent droplets, thereby creating a concentrated reagent slurry;
precipitating in a WESP a combination comprised of the concentrated reagent slurry, the ash particles of the industrial waste gas, and droplets of acid, by flowing the combination through a plurality of negatively charged ionizing electrodes surrounded by a plurality of positively charged plates;
creating a liquid film of a second slurry comprised of precipitated particles of ash, precipitated droplets of concentrated reagent slurry, precipitated droplets of acid, and NO;
flowing the liquid film of the second slurry over an oxidizing surface of a reactor such that the liquid film of the second slurry continuously cleans the oxidizing surface;
measuring a pH of the liquid film of the second slurry;
injecting droplets of acid into the industrial waste gas if the pH of the liquid film of the second slurry is below a predetermined level;
generating ozone and chlorine dioxide in the WESP; and
oxidizing NO of the liquid film of the second slurry into NO₂ using the ozone and chlorine dioxide generated in the WESP.
